(19) United States
(12) Patent Application Publication
(10) Pub. No.: US 2017/0317382 A1
(43) Pub. Date: Nov. 2, 2017

(54) BATTERY MADE FROM A SINGLE MATERIAL

(71) Applicant: University of Maryland, College Park, MD (US)

(72) Inventors: Chunsheng Wang, Silver Spring, MD (US); Fudong Han, Hyattsville, MD (US)

(21) Appl. No.: 15/583,479

(22) Filed: May 1, 2017

Related U.S. Application Data
(60) Provisional application No. 62/329,828, filed on Apr. 29, 2016.

(51) Int. Cl. H01M 10/0562; H01M 4/58; H01M 4/36; H01M 4/587; H01M 10/0525

(52) U.S. Cl. CPC H01M 10/0562; H01M 4/587; H01M 10/0525; H01M 4/364; H01M 4/5815; H01M 2300/0068

(57) ABSTRACT

A solid-state lithium-ion battery may include an anode, a solid electrolyte layer of material, and a cathode. Each consist of the solid electrolyte material and are interspersed with a current collector material such that electrical conductivity is enabled between the anode and the cathode via the solid electrolyte layer to form a solid state lithium ion battery made from a single material in common to the anode, the solid electrolyte layer and the cathode. A method of manufacturing a solid-state lithium-ion battery includes cold pressing Li₁₀GeP₂S₁₂/C anode composite layer, LGPS solid electrolyte layer, and Li₁₀GeP₂S₁₂/C cathode composite layer to enable electrical conductivity between the anode and cathode composite layers via the LGPS solid electrolyte layer. The material may alternatively include Li₃PS₄, Li₄GeS₄, Li₂S—SiS₂, Li₁₀SnP₂S₁₂, and LiVPO₄F or other materials not specifically identified.

### CROSS-REFERENCE TO RELATED APPLICATIONS

This application claims the benefit of, and priority to, U.S. Provisional Patent Application No. 62/329,828, filed on Apr. 29, 2016, entitled “Battery Made From A Single Material”, by Chunsheng Wang et al., the entire contents of which is incorporated by reference herein.

### STATEMENT OF GOVERNMENT SUPPORT

This invention was made with government support under CBET1235719 awarded by the U.S. National Science Foundation (NSF). The government has certain rights in the invention.

### BACKGROUND

### 1. Technical Field

The present disclosure relates to lithium ion batteries and more particularly to solid-state lithium ion batteries.

### 2. Discussion of Related Art

All-solid-state lithium-ion batteries (ASSLIBs) are receiving intense interest for energy storage systems because the replacement of the volatile and flammable liquid electrolyte¹ with nonflammable inorganic solid electrolyte could essentially improve the safety and reliability of the battery. The conventional ASSLIBs consist of three distinct components: an anode, an electrolyte, and a cathode. In addition, current collectors are also used to ensure electron transport through the electrodes and the external circuit.² The anode, cathode, and electrolyte normally use three different materials due to the stringent different requirements for each component.

The electrodes are expected to be reversibly lithiated/delithiated at a low potential (anode) or a high potential (cathode) with good mixed electronic/ionic conductivities, whereas the electrolyte should have a wide electrochemical stability window with a very high ionic conductivity, but negligible electronic conductivity. To develop a highly-performed ASSLIB, two critical challenges have to be overcome; one is the high ionic resistance of the solid electrolyte and the other is the large interfacial resistance between the solid electrodes and solid electrolyte. Because of the great success in minimizing the solid electrolyte thickness based on a series of advanced deposition techniques, thin-film ASSLIBs (total thickness ˜15 μm) using low-conductivity solid electrolyte (LIPON with σ_{Li}˜10⁻⁶ S/cm) have received extensive research.^{3, 4} Despite excellent cycle stability, the limited stored energy (<100 μAh/cm²) and the expensive, multistep fabrication process of this thin-film battery are still the main obstacles towards their wide applications.

### SUMMARY

To address the foregoing disadvantages of the prior art, the present disclosure relates to a solid-state lithium-ion battery made from a single material. The material itself is a solid electrolyte, but could also be used as cathode and anode after mixing with carbon. More particularly, the solid-state lithium-ion battery includes an anode; a solid electrolyte layer of material; and a cathode, wherein the anode and the cathode each consist of the solid electrolyte material and are interspersed with a current collector material such that electrical conductivity is enabled between the anode and the cathode via the solid electrolyte layer to form thereby a solid state lithium ion battery made from a single material in common to the anode, the solid electrolyte layer and the cathode.

In an embodiment, the single material in common for the solid electrolyte layer and the anode and the cathode is selected from the group consisting of Li₁₀GeP₂S₁₂, Li₃PS₄, Li₄GeS₄, Li₂S—SiS₂, Li₁₀SnP₂S₁₂, and LiVPO₄F.

In an embodiment, the current collector material is carbon.

In an embodiment, the carbon is selected from the group consisting of graphite, acetylene black, Carbon Black Super P® Conductive, and carbon black.

In an embodiment, the solid-state lithium-ion battery further includes a stainless steel current collector in electrical communication with the current collector material interspersed in the anode; and a stainless steel current collector in electrical communication with the current collector material interspersed in the cathode.

In an embodiment, the single material in common for the anode; the single material in common for the solid electrolyte layer of material, and the single material for the cathode consists of Li₁₀GeP₂S₁₂ (LGPS), wherein the anode, the cathode and the solid electrolyte layer are interspersed with the current collector material such that electrical conductivity is enabled between the anode and the cathode via the solid electrolyte layer to form thereby the solid state lithium ion battery made from a single material in common to the anode, the solid electrolyte layer and the cathode.

In an embodiment, again the current collector material may be carbon.

In an embodiment, again the carbon is selected from the group consisting of graphite, acetylene black, Carbon Black Super P® Conductive, and carbon black.

In an embodiment, the carbon composite anode consists of a Li₁₀GeP₂S₁₂ carbon composite (LGPS/C) anode; the solid electrolyte layer of material is a LGPS solid electrolyte layer; and the carbon composite cathode consists of a Li₁₀GeP₂S₁₂ carbon composite (LGPS/C) cathode, such that electrical conductivity is enabled between the carbon composite anode and the carbon composite cathode via the LGPS solid electrolyte layer to form thereby the solid state lithium ion battery made from a single material.

In an embodiment, the carbon contained in the carbon composite anode and the carbon contained in the carbon composite cathode act as current collectors, and the solid-state lithium-ion battery further includes a stainless steel current collector in electrical communication with the carbon contained in the carbon composite anode; and a stainless steel current collector in electrical communication with the carbon contained in the carbon composite cathode.

In an embodiment, the LGPS solid electrolyte is manufactured by: mixing Li₂S, GeS₂, and P₂S₅ in a vibrating mill to form a mixture; pressing the mixture into pellets; sealing the pellets in an evacuated container: and heating the evacuated container at a temperature and for a time period sufficient to form Li₁₀GeP₂S₁₂

In an embodiment, the sealing in and heating of the evacuated container include sealing the pellets in and heating an evacuated quartz tube.

In an embodiment, heating the evacuated container includes heating the evacuated container at a temperature included in a temperature range that includes 550° C.

In an embodiment, heating the evacuated container at a temperature included in a temperature range that includes 550° C. includes heating the evacuated container at a temperature ranging from 100° C. to 1000° C.

In an embodiment, heating the evacuated container at a temperature ranging from 100° C. to 1000° C. includes heating the evacuated container at a temperature ranging from 200° C. to 900° C.

In an embodiment, heating the evacuated container at a temperature ranging from 200° C. to 900° C. includes heating the evacuated container at a temperature ranging from 300° C. to 800° C.

In an embodiment, heating the evacuated container at a temperature ranging from 300° C. to 800° C. includes heating the evacuated container at a temperature ranging from 400° C. to 700° C.

In an embodiment, heating the evacuated container at a temperature ranging from 400° C. to 700° C. includes heating the evacuated container at a temperature ranging from 500° C. to 600° C.

In an embodiment, the heating the evacuated container at a temperature and for a time period sufficient to form Li₁₀GeP₂S₁₂ includes heating the evacuated container for a time period included in a time period range that includes 8 hours,

In an embodiment, heating the evacuated container for a time period included in a time period range that includes 8 hours includes heating the evacuated container for a time period ranging from 2 to 14 hours.

In an embodiment, heating the evacuated container for a time period ranging from 2 to 14 hours includes heating the evacuated container for a time period ranging from 3 to 13 hours.

In an embodiment, heating the evacuated container for a time period ranging from 3 to 13 hours includes heating the evacuated container for a time period ranging from 4 to 12 hours.

In an embodiment, heating the evacuated container for a time period ranging from 4 to 12 hours includes heating the evacuated container for a time period ranging from 5 to 11 hours.

In an embodiment, heating the evacuated container for a time period ranging from 5 to 11 hours includes heating the evacuated container for a time period ranging from 6 to 10 hours.

In an embodiment, heating the evacuated container for a time period ranging from 6 to 10 hours includes heating the evacuated container for a time period ranging from 7 to 9 hours.

In an embodiment, the Li₁₀GeP₂S₁₂ carbon composite (LGPS/C) anode and the Li₁₀GeP₂S₁₂/C carbon composite (LGPS/C) cathode are manufactured by: mixing Li₁₀GeP₂S₁₂ with a carbon material to prepare a Li₁₀GeP₂S₁₂/C cathode composite and an Li₁₀GeP₂S₁₂/C anode composite; compiling Li₁₀GeP₂S₁₂ powder as a LGPS solid electrolyte; depositing the Li₁₀GeP₂S₁₂/C anode composite on a first surface of the LGPS solid electrolyte to form an anode and current collector composite layer on the first surface of the LGPS solid electrolyte layer; depositing the Li₁₀GeP₂S₁₂/C cathode composite on a second surface of the LGPS solid electrolyte to form a cathode and current collector composite layer on the second surface of the LGPS solid electrolyte layer; and cold pressing the Li₁₀GeP₂S₁₂/C anode and current collector composite layer, the LGPS solid electrolyte layer, and the Li₁₀GeP₂S₁₂/C cathode and current collector composite layer at a pressure sufficient to enable electrical conductivity between the anode composite layer and the cathode composite layer via the LGPS solid electrolyte layer to form thereby the solid state lithium ion battery made from a single material.

In an embodiment, cold pressing the Li₁₀GeP₂S₁₂/C anode composite layer, the LGPS solid electrolyte layer, and the Li₁₀GeP₂S₁₂/C cathode composite layer at a pressure sufficient to enable electrical conductivity between the anode composite layer and the cathode composite layer via the LGPS solid electrolyte layer includes cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 300 MPa to 500 MPa.

The present disclosure relates also to a method of manufacturing a solid-state lithium-ion battery that includes mixing Li₁₀GeP₂S₁₂ with a carbon material to prepare a Li₁₀GeP₂S₁₂/C cathode and current collector composite and an Li₁₀GeP₂S₁₂/C anode and current collector composite; compiling Li₁₀GeP₂S₁₂ powder as a LGPS solid electrolyte; depositing a Li₁₀GeP₂S₁₂/C anode composite on a first surface of an LGPS solid electrolyte to form an anode and current collector composite layer on the first surface of the LGPS solid electrolyte layer; depositing a Li₁₀GeP₂S₁₂/C cathode composite on a second surface of the LGPS solid electrolyte to form a cathode and current collector composite layer on the second surface of the LGPS solid electrolyte layer; and cold pressing the Li₁₀GeP₂S₁₂/C anode and current collector composite layer, the LGPS solid electrolyte layer, and the Li₁₀GeP₂S₁₂/C cathode and current collector composite layer at a pressure sufficient to enable electrical conductivity between the anode and current collector composite layer and the cathode and current collector composite layer via the LGPS solid electrolyte layer to form thereby a solid state lithium ion battery made from a single material.

In an embodiment, cold pressing the Li₁₀GeP₂S₁₂/C anode composite layer, the LGPS solid electrolyte layer, and the Li₁₀GeP₂S₁₂/C cathode composite layer at a pressure sufficient to enable electrical conductivity between the anode composite layer and the cathode composite layer via the LGPS solid electrolyte layer includes cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa.

In an embodiment, cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 300 MPa to 500 MPa.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-mentioned advantages and other advantages will become more apparent from the following detailed description of the various exemplary embodiments of the present disclosure with reference to the drawings wherein:

FIG. 1A is a schematic diagram of a bulk-type all-solid-state lithium-ion battery according to the prior art;

FIG. 1B is a schematic diagram of a single Li₁₀GeP₂S₁₂ (LGPS) all-solid-state lithium-ion battery according to one embodiment of the present disclosure:

FIG. 2A is an X-ray diffraction pattern and a Rietveld refinement of LGPS powder after synthesis; FIG. 2A′ is the background X-ray diffraction pattern of the tape used for testing the LGPS powder;

FIG. 2B is a scanning electron microscope image of the as-prepared LGPS powder after synthesis;

FIG. 2C is Arrhenius conductivity plots in log [σ(S cm⁻¹)] versus inverse of temperature in K⁻¹ of the LGPS.

FIG. 2C′ illustrates electrochemical impedance Z(Ω) spectroscopy measured with Au/LGPS/Au cell at different temperatures in K.

FIG. 2D shows a plot of Current (mA) versus Voltage (V) vs. Li/Li⁺ representing the electrochemical window of the LGPS powder obtained from cyclic voltammetry (CV) of a Li/LGPS/Pt cell at a scan rate of 0.05 mV/s.

FIG. 2D′ illustrates a plot also representing Current (mA) versus Voltage (V) vs. Li/Li⁺,

FIG. 3A illustrates charge/discharge curves of the Li/LGPS/LGPS-C all-solid-state cell at a current density of 10 mA/g in the voltage range of 1.5-3.5 V;

FIG. 3B illustrates charge/discharge curves of the Li/LGPS/LGPS-C all-solid-state cell at a current density of 10 mA/g in the voltage range of 0.0-2.0 V;

FIG. 3C illustrates charge/discharge curve of the Li/LGPS/LGPS-C all-solid-state cell at different current densities in the voltage range of 1.5-3.5 V;

FIG. 3D illustrates charge/discharge curve of the Li/LGPS/LGPS-C all-solid-state cell at different current densities in the voltage range of 0.0-2.0 V;

FIG. 4A illustrates cross-section scanning electron microscope (SEM) images of the single-LGPS battery;

FIG. 4B illustrates elemental mappings of C (red) and S (blue) of the single-LGPS battery;

FIG. 4C is a high-magnification SEM image displaying the interface between LGPS electrode and LGPS electrolyte;

FIG. 4D illustrates charge/discharge curves of the single-LGPS battery in the voltage range of 0.0-2.5 V from the 2^{nd} cycle at a current density of 10 mA/g;

FIG. 4E illustrates charge/discharge curves of the single-LGPS battery in the voltage range of 0.0-2.5 V from the 2^{nd} cycle at different current densities;

FIG. 4F illustrates charge/discharge curves of the single-LGPS battery in the voltage range of 0.0-2.5 V from the 2^{nd} cycle at 50° C. at a current density of 50 mA/g;

FIG. 5 is a schematic representation of the cell configuration for all-solid-state battery test and illustrates the construction of the single material all solid state lithium ion battery;

FIG. 6 is a schematic block diagram of a method of manufacturing an LGPS solid electrolyte;

FIG. 7A is a schematic block diagram of a method of manufacturing an all-solid-state lithium-ion battery made from a single material according to one embodiment of the present disclosure; and

FIG. 7B is a continuation of the schematic block diagram of FIG. 7A of a method of manufacturing an all-solid-state lithium-ion battery made from a single material.

### DETAILED DESCRIPTION

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments.

It is to be understood that the method steps described herein need not necessarily be performed in the order as described. Further, words such as “thereafter,” “then,” “next,” etc., are not intended to limit the order of the steps. Such words are simply used to guide the reader through the description of the method steps.

Bulk-type all-solid-state lithium-ion batteries with nonflammable inorganic solid electrolyte are being considered as the ultimate solution for safe lithium-ion batteries. The current all-solid-state lithium-ion batteries suffer from low power density mainly due to a strong kinetic limitation at the electrode/electrolyte interface. Here, we report a novel concept of a single-material all-solid-state lithium-ion battery, wherein a single Li₁₀GeP₂S₁₂ serves as an electrolyte, an anode, and a cathode, to eliminate the highly-resistive interface between the electrodes and electrolyte. The realization of the single-Li₁₀GeP₂S₁₂ battery is based on the fact that the Li—S and Ge—S components in Li₁₀GeP₂S₁₂ could act as the active centers for lithiation/delithiation as a cathode and an anode, respectively, when electronically-conductive carbon is mixed, while pure Li₁₀GeP₂S₁₂ can be used as an electrolyte. This unique concept of a single-material lithium-ion battery can be extended to other solid-state battery systems, providing a new direction for high-power, high-energy, long-cycling solid-state batteries.

Although the single-material battery based on Li₁₀GeP₂S₁₂ was illustrated here, it should be noted that the single-battery concept is not limited to this material. Any solid electrolytes that has reversible decompositions at two different voltages could work as the material for the single material battery. The examples for these materials include but are not limited to Li₃PS₄, Li₄GeS₄, Li₂S—Si S₂, Li₁₀SnP₂S₁₂, LiVPO₄F.

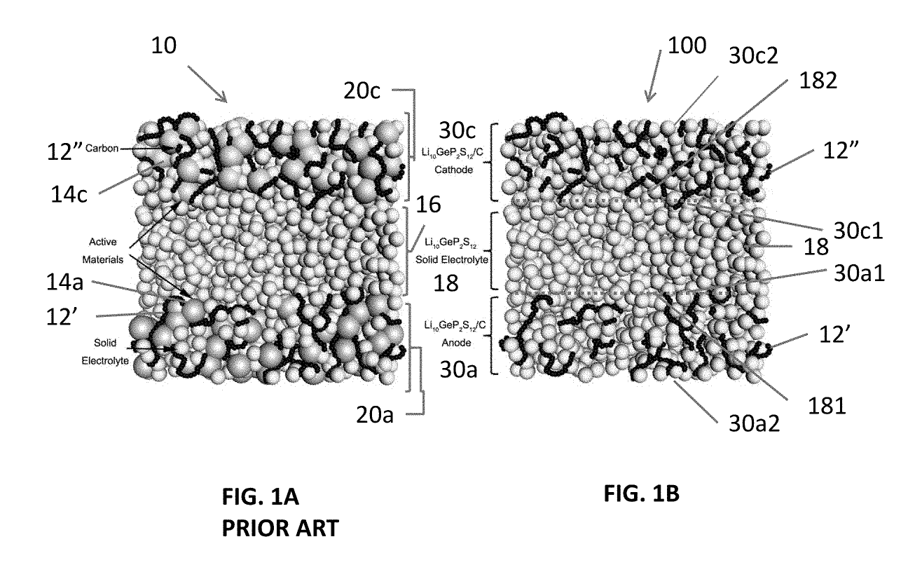

FIG. 1A illustrates a bulk-type all-solid-state lithium-ion battery 10 as known in the art. The battery 10 includes a solid state anode layer 20a, a solid state electrolyte layer 16, and a solid state cathode layer 20c such that the solid state anode layer 20a and the solid state cathode layer 20c enable electrical conductivity therebetween via the solid electrolyte 16.

The solid state anode layer 20a includes portions of the solid electrolyte 16 having interweaved carbon 12′ and further includes, for example, anode material 14a that may be graphite, silicon, Li₄Ti₅O₁₂, or Fe₂O₃.

The solid state cathode layer 20c includes also portions of the solid electrolyte 16 having interweaved carbon 12″ and further includes, for example, cathode material 14c that may be LiCoO₂, LiMn₂O₄, LiFePO₄, or sulfur.

The solid electrolyte layer 16 may include, for example, Li₃PS₄, Li₄GeS₄, Li₂S—SiS₂, Li₁₀GeP₂S₁₂, LiVPO₄F, Li₇La₃Zr₂O₁₂.

Increasing the thickness of the electrodes 20a and 20c and electrolyte 16 to make the so-called bulk-type ASSLIBs, e.g., battery 10 in FIG. 1A is highly desired for their widespread use in the large-scale energy storage systems. However, the performance of this type of battery, especially in terms of power density and cycle life, is too low for their practical applications. This is because the increase in the thickness of the battery would require a very high conductivity of the solid electrolyte and a very low interfacial resistance between the electrodes and electrolyte.⁵ Considerable efforts have been focused on developing highly conductive solid electrolytes.⁶⁻⁸ Even though the solid electrolyte with a comparable or a higher ionic conductivity than the liquid electrolyte was used, and more electrolyte (˜50 wt. % compared with ˜30 vol. % for liquid-electrolyte LIBs) and a large amount of electronically-conductive additive (25 wt. % carbon for Li₂S) were added in the composite electrodes, the rate and cycling performances of the bulk-type ASSLIBs are still much lower than those of the liquid-electrolyte LIBs. Bulk-type ASSLIBs using ductile sulfide electrolytes (σ_{Li}>10⁻³ S/cm) are usually operated at very low current densities,⁹⁻¹¹ and the ASSLIBs using rigid oxide electrolytes (e.g. garnet-type Li₇La₃Zr₂O₁₂ with σ_{Li}>10′⁻⁴ S/cm) can hardly even be cycled because of the huge overpotentials during the charge/discharge process.¹² These results indicate that the interfacial resistance between the solid electrodes and solid electrolyte is becoming the dominant kinetic limitation, given the significantly-decreased resistance of the electrolyte layer by using the highly conductive solid electrolyte.¹³

The highly-resistive interface was considered to result from the insufficient contact between solid electrodes and solid electrolyte because the solid electrolytes are not wettable and infiltrative like liquids.⁵ The poor interfacial contact restricts the fast transport of lithium ions and also decreases the number of active sites for charge transfer reaction. Various attempts have been made to improve the interfacial contact by reducing the electrode particle-size,¹⁴ uniaxial or dynamic pressing,^{9, 15} molten-salt,^{16, 17} screen-printing,¹⁸ lattice-matching,¹⁹ and one-step spark plasma sintering methods.^{20, 21} However, only limited success in enhancing the power density has been achieved because a highly-resistive interfacial phase layer might also be generated from the unwanted chemical reactions²²⁻²⁵ and elemental inter-diffusions²⁶ between the different electrode and electrolyte materials during either synthesis or the charge/discharge cycles. Even worse, the intimate initial contact achieved in the fabrication and/or sintering process may even accelerate the unwanted chemical reactions and elemental inter-diffusions. In addition, the space-charge layers formed at the hetero-interface between the electrode and electrolyte, due to their electrochemical potential difference, might also increase the interfacial resistance.²⁷⁻²⁹ To minimize these unwanted interfacial interactions (chemical reactions, elemental inter-diffusions and space-charge layer formations), intentional surface coatings with various materials, including ionically conductive,^{27, 30} electronically conductive,³¹ or even insulating layers,³² on the electrodes were also reported. Despite apparent improvements using the above-mentioned methods, the interfacial resistance still remains too high and may even continuously increase with charge/discharge cycles. The continuous increase of the interfacial resistance with charge/discharge cycles could be mainly related to the high strain/stress generated at the interface because the large volume changes of the electrodes (especially for the high-capacity electrodes) during lithiation/delithiation are highly constrained by the solid electrolyte.³³ Unfortunately, this problem gets even worse for a thicker electrode that is desired for a high energy-density battery.

As discussed above, the high and continuously-increased interfacial resistance is mainly induced by:

(1) the poor physical contact between the solid electrodes and solid electrolyte;
(2) the unwanted interfacial interactions between the solid electrodes and solid electrolyte, such as chemical reactions, elemental inter-diffusions and space-charge layer formations;
(3) the stress/strain at the interface.

Accordingly, all of these aspects, instead of only one that was concerned in most previous works, should be considered in order to achieve a low-resistance interface during long-term charge/discharge cycles. However, it is very challenging to address all of them simultaneously in the conventional ASSLIBs because they use different materials for the electrodes and electrolyte, wherein the intimate interfacial contact is very hard to achieve, and the interfacial interactions and the strain/stress at the interface are very difficult to control and sometimes are even unavoidable.

As illustrated in FIG. 1B, the present disclosure relates to a novel single-material ASSLIB 100 to address the interfacial problem, wherein the cathode, electrolyte, and anode are made from a single material. More particularly, single-material ASSLIB 100 includes a solid state anode layer 30a, a solid state electrolyte layer 18, and a solid state cathode layer 30c such that the solid state anode layer 30a and the solid state cathode layer 30c enable electrical conductivity therebetween via the solid electrolyte 18.

However, the solid state anode layer 20a only includes portions of solid electrolyte 16 having interweaved carbon 12′ and does not further include any other anode materials.

Similarly, the solid state cathode layer 20c only includes portions of solid electrolyte 16 having interweaved carbon 12″ and does not further include any other cathode materials.

The solid electrolyte layer 18 now includes highly-conductive Li₁₀GeP₂S₁₂ (LGPS) electrolyte as both a cathode and an anode after mixing with electronically-conductive carbon 12′ or 12″.

The feasibility of using the highly-conductive Li₁₀GeP₂S₁₂(LGPS) electrolyte as both a cathode and an anode after mixing with electronically-conductive carbon allows usage as a model material for the single-material ASSLIB.

It would be expected that a perfect physical contact between the electrodes and electrolyte could be intrinsically achieved, the unwanted interfacial interactions could be avoided, and the strain/stress at the interface could be alleviated.

As a result, a superior electrode/electrolyte interface with an extremely low resistance could be achieved in the single-LGPS ASSLIB, beneficial to a high-power, high-energy, and long-cycling all-solid-state battery.

Results

Feasibility of a Single-material All-solid-state Lithium-ion Battery.

Ideally, a perfect electrolyte should have intrinsic thermodynamic electrochemical stability within the working voltage window of the battery, because the electrolyte may be oxidized at a high potential and reduced at a low potential beyond its electrochemical stability window.

This tough thermodynamic requirement, however, does not have to be satisfied for the electrolytes of which the oxidation and reduction reactions are extremely slow and/or are suppressed by forming a passivating layer.

A typical example is that a commercialized lead-acid battery based on an aqueous electrolyte could operate over 2.0 V, which is 0.77 V wider than the thermodynamic stability window of water (1.23 V).³⁴

However, if the electrochemical reaction occurring beyond the stability window of the electrolyte can be accelerated and is reversible, the electrolyte may be used as an electrode.

For instance, Li_{0.29}La_{0.57}TiO₃ could serve as an insertion electrode at potentials below its cathodic limit ˜1.7 V (vs. Li/Li⁺) after mixing with carbon.³⁵

These facts provide opportunities for us to find an electrolyte material which has a high lithium-ion conductivity and a very low electronic conductivity in its pure state, but becomes an electrode after mixing with an electronically-conductive additive such as carbon (electrolyte-carbon composite) due to the significantly-improved kinetics for the reversible lithiation/delithiation (oxidation/reduction) reactions.

Moreover, if such an electrolyte-carbon composite can be electrochemically and reversibly reduced/oxidized at two different potentials, we may use it as both the cathode and anode. Therefore, an ASSLIB using a single material—an electrolyte without carbon and a cathode and an anode with carbon—could become possible, wherein the electronically-conductive carbon could be considered as current collectors.

It should also be mentioned that the single-material ASSLIB is fundamentally different from the in-situ prepared thin-film ASSLIB under a 16 V D.C. voltage,³⁶ wherein the anode was obtained by the decomposition of the solid electrolyte (Li_{1+x+y}Al_{y}Ti_{2-y}SiₓP₃₋ₓO₁₂, OHARA Inc.) under an external driving force, and the MnO₂ cathode (distinct from the parent electrolyte) was prepared by the reaction between the current collector (Mn) and the released oxygen ions from the decomposition of the solid electrolyte.³⁶

With the above considerations, Li₁₀GeP₂S₁₂was used as a model material to demonstrate the single-material battery concept.

LGPS is a great solid electrolyte with a wide electrochemical window (˜5.0 V) and the highest ionic conductivity (σ_{Li}˜10⁻² S/cm) in all solid electrolytes.⁷

Several >4.0 V ASSLIBs using LGPS as the solid electrolyte have also been fabricated.^{37, 38}

However, the measured wide stability window of 5.0 V benefits from the poor kinetics of the oxidation and reduction reactions of LGPS due to its low electronic conductivity (σₑ˜10⁻⁹ S/cm)⁷, since the intrinsic thermodynamic stability window of LGPS is calculated to be only less than 2.5 V.³⁹

The theoretical calculation from first principle modeling also indicates that LGPS will be oxidized to P₂S₅, S, and GeS₂ at high potentials and be reduced to Li₂S, Li₃P and Li₁₅Ge₄ at low potentials.³⁹

These results imply that the both the oxidation and reduction reactions occurring beyond the stability window of LGPS should be reversible, and LGPC-carbon composite may be used as both a cathode and anode due to the enhanced reaction kinetics.

Actually, the Li—S component in LGPS has the same local structure as that in Li₂S, which is a well-accepted cathode with a theoretical capacity of 1166 mAh/g at ˜2.2 V,^{14, ′}indicating that LGPS may probably function as a cathode after mixing with carbon.

In addition, it is known that the Sn—O component contained in Sn_{1.0}B_{0.56}P_{0.40}Al_{0.42}O_{3.6} (TCO glass) is still electro-active for lithiation/delithiation as an anode even after a new phase formation.⁴¹

Given the similarity between Sn—O in TCO and Ge—S in LGPS, LGPS may also function as an anode after mixing with carbon, since GeS₂ is a well-accepted anode with a theoretical capacity of 863 mAh/g at ˜0.5 V.^{42, 43}

Thus, after mixing with carbon, LGPS could be able to serve as both a cathode and an anode. At a low potential the Ge—S component will be active for lithiation/delithiation but the Li—S component will remain inactive, and at a high potential only the Li—S component will be active.

Therefore, pure LGPS could be used as the solid electrolyte while LGPS-carbon composites (LGPS/C) could serve as both a cathode and an anode.

A single-LGPS ASSLIB could be fabricated by simply sandwiching LGPS/C cathode, LGPS solid electrolyte, and LGPS/C anode (see FIG. 1B), wherein carbon is considered as the extension of current collectors.

The feasibility of the single-LGPS ASSLIB has also been experimentally demonstrated. LGPS was synthesized following Ref. 7.

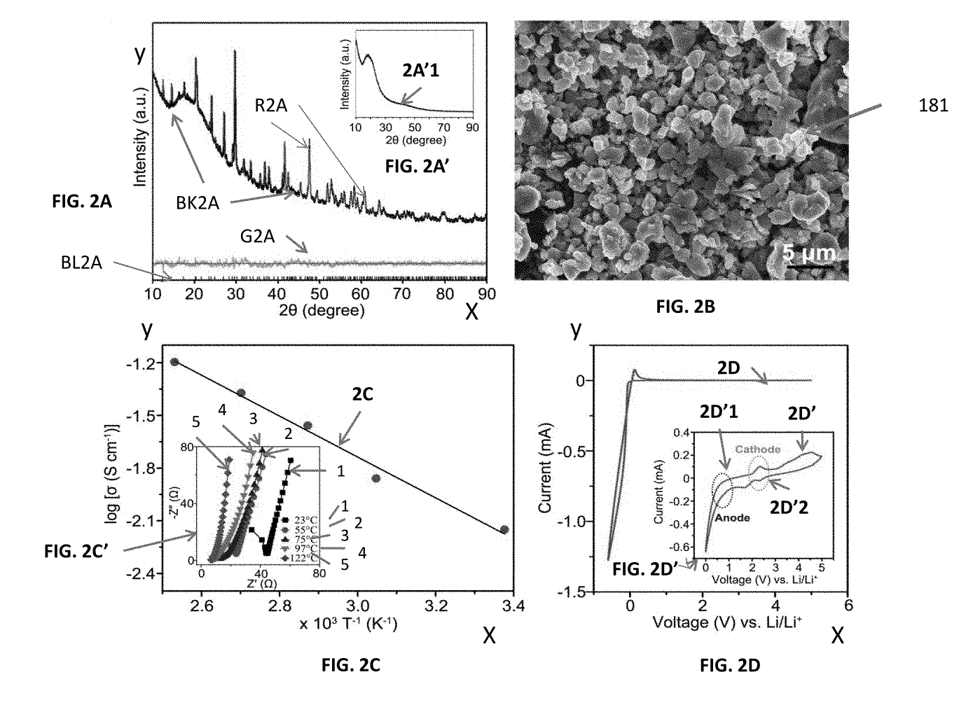

FIG. 2A is an X-ray diffraction pattern and a Rietveld refinement of LGPS powder after synthesis.

The Y axis is intensity in a.u. The X axis is 2θ in degrees. The black BK2A, red R2A and green lines G2A represent the experimental, calculated and difference patterns, respectively. The blue markers BL2A correspond to the position of diffraction lines. FIG. 2A′shows the background XRD pattern 2A′1 in intensity (a.u.) versus 2θ in degrees of the tape used for testing. The Rietveld refinement of its X-ray powder diffraction pattern indicates that the as-obtained LGPS has a typical space group of P4₂/nmc with the cell parameters of a=8.6995(3) Å, c=12.669(6) Å, and V=954.1 Å³, which is in good agreement with the previous report.⁷ The atomic ratio of P to Ge in the sample was determined to be 2.06 by inductively coupled plasma (ICP) spectroscopy, consistent with the stoichiometric ratio of P/Ge=2 in Li₁₀GeP₂S₁₂.

FIG. 2B is a scanning electron microscope image of the as-prepared LGPS powder 180 The SEM image reveals that the particle size of the sample is about 2-5 μm.

FIG. 2C is Arrhenius conductivity plots 2C in log [σ(S cm⁻¹)] (Y-axis) versus inverse of temperature in K⁻¹ (X-axis) of the LGPS powder 18.

FIG. 2C′ illustrates electrochemical impedance Z(Ω) spectroscopy measured with Au/LGPS/Au cell at different temperatures 1, 2, 3, 4 and 5, in K, corresponding 23° C., 55° C., 75° C., 97° C., and 122° C., respectively.

Thus, FIG. 2C shows the Arrhenius plot 2C of LGPS powder 181 calculated from the impedance spectroscopy shown in the inset FIG. 2C′. The ionic conductivities of LGPS powder 181 including both grain boundary and bulk conductivities are in the order of 10⁻² S/cm over the entire temperature range from 23 to 122° C., similar to the reported values.⁷ The activation energy for the ionic transport was calculated to be 0.26 eV.

FIG. 2D shows a plot 2D of Current (mA) (Y-axis) versus Voltage (V) vs. Li/Li⁺ (X-axis) representing the electrochemical window of the LGPS powder 181 obtained from cyclic voltammetry (CV) of a Li/LGPS/Pt cell at a scan rate of 0.05 mV/s. The LGPS is observed to be stable at a high potential up to 5.0 V, which agrees well with the previous report.^{7, 38}

However, as shown in FIG. 2D′ illustrating plot 2D′ also representing Current (mA) versus Voltage (V) vs. Li/Li⁺, when an LGPS-C layer (LGPS:carbon is 75:25 in weight) was inserted between LGPS and Pt in Li/LGPS/Pt to form a Li/LGPS/LGPS-C/Pt cell, two pairs of reversible redox peaks 2D′1 and 2D′2 could be observed in the CV curve measured at the same scan rate; 2D′2 is located at 2.0-2.5 V and the 2D′1 is at 0.0-0.5 V. This result demonstrates that an LGPS-C composite may serve as both a cathode at 2.0-2.5 V and an anode at 0.0-0.5 V.

In FIG. 2D, the lack of these peaks in the CV of the Li/LGPS/Pt cell is due to the reactions of LGPS being highly restricted by the limited contact area between LGPS and electronically-conductive Pt, as well as the high scan rate. In fact, the electrochemical oxidation and reduction reactions beyond the stability window of LGPS, at the interface between the LGPS and Au in the Au/LGPS/Au blocking electrode, have been detected using the sensitive electrochemical impedance spectrum (EIS) The EIS of the fresh Au/LGPS/Au electrode shows a typical Nyquist plot of a solid electrolyte with a nearly vertical capacitive line for blocking electrodes. However, after a linear potential scan of the Au/LGPS/Au blocking electrode at a very low scan rate of 0.005 mV/s from 0.0 to 2.7 V, the Nyquist plot turns into a typical battery-like behavior with charge-transfer semi-circles in the medium frequency and a near 45° slope diffusion line in the low frequency.

This result demonstrates that even the Au/LGPS/Au blocking electrode may turn into a single-LGPS micro-battery because the LGPS electrolyte contacting Au would be oxidized and reduced as electrodes.³⁶ These results indicate that it is feasible to fabricate an ASSLIB based on the single material LGPS.

Electrochemical performances of Li₁₀GeP₂S₁₂ as a cathode and an anode. The electrochemical performances of LGPS-C electrodes (LGPS:carbon is 75:25 in weight) were firstly tested in a coin cell using the liquid electrolyte (1 M LiTFSI in TEGDME and PYR₁₃TFSI). The cathode performance of LGPS was evaluated in the potential range between 1.0 to 3.5 V (vs. Li/Li⁺) and the anode performance was measured between 0.0 and 2.0 V.

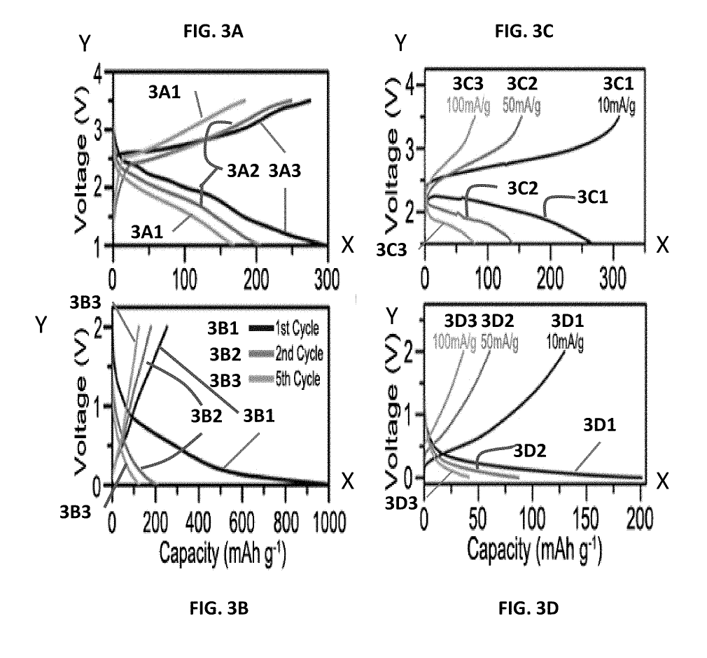

FIGS. 3A-3D illustrate electrochemical performance of Li₁₀GeP₂S₁₂ cathode and anode with Li₁₀GeP₂S₁₂ solid electrolyte in terms of voltage (V) (Y-axis) and capacity (mAh/g).

More particularly, FIG. 3A illustrates three charge/discharge curves 3A1, 3A2 and 3A3 of the Li/LGPS/LGPS-C all-solid-state cell at a current density of 10 mA/g in the voltage range of 1.5-3.5 V.

FIG. 3B illustrates three charge/discharge curves 3B1 for the first cycle, 3B2 for the second cycle, and 3B2 for the third cycle in the voltage range of 0.0-2.0 V

FIG. 3C illustrates three charge/discharge curves of the Li/LGPS/LGPS-C all-solid-state cell at different current densities 3C1 at 10 mA/g, 3C2 at 50 mA/g and 3C3 at 100 mA/g in the voltage range of 1.5-3.5 V.

Similarly, FIG. 3D, illustrates three charge/discharge curves of the Li/LGPS/LGPS-C all-solid-state cell at different current densities 3D1 at 10 mA/g, 3D2 at 50 mA/g and 3D3 at 100 mA/g in the voltage range of 0.0-2.0 V.

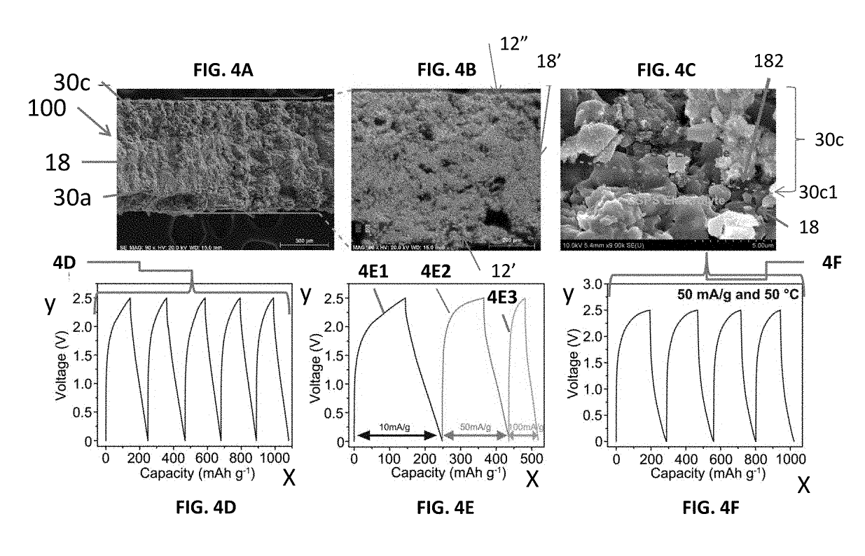

FIGS. 4A-4F illustrate the electrochemical performance of the single-Li₁₀GeP₂S₁₂ battery.

More particularly, FIG. 4A is a cross-section of SEM images of the single-LGPS battery 100. FIG. 4B illustrates elemental mappings of C (red) 12′ and 12″ and S (blue) 18′ of the single-LGPS battery 100.

FIG. 4C is a high-magnification SEM image displaying the interface between LGPS electrode and LGPS electrolyte.

In FIGS. 4D-4F, the Y axis is voltage (V) and the X axis is capacity in mAh/g.

More particularly, FIG. 4D illustrates charge/discharge curves 4D of the single-LGPS battery 100 or 110 in the voltage range of 0.0-2.5 V from the 2^{nd} cycle at a current density of 10 mAh/g to the 6^{th} cycle at a current density of approximately 1200 mAh/g. The weight ratio of LGPS cathode to LGPS anode was tentatively set as 3 for the capacity balance, and the specific capacity was calculated based on the weight of LGPS anode.

FIG. 4E illustrates charge/discharge curves of the single-LGPS battery in the voltage range of 0.0-2.5 V from the 2^{nd} cycle at different current densities in mA/g. More particularly, charge/discharge curve 4E1 is taken at a current density of 10 mA/g extending from a capacity of 0 to 250 mAh/g. Charge/discharge curve 4E2 is taken at a current density of 50 mA/g extending from a capacity of 250 to about 430 mAh/g. Charge/discharge curve 4E3 is taken at a current density of 100 mA/g extending from a capacity of about 430 to about 520 mAh/g.

FIG. 4F illustrates charge/discharge curves 4F of the single-LGPS battery in the voltage range of 0.0-2.5 V from the 2^{nd} cycle at 50° C. at a current density of 50 mA/g.

The weight ratio of LGPS cathode to LGPS anode was tentatively set as 3 for the capacity balance. The specific capacity and the current density of the all-solid-state full cells were calculated based on the weight of LGPS anode. All the electrochemical perfomances of the batteries were tested at room temperature unless specified.

As evident from FIGS. 4D-4E-4F, the LGPS/LGPS full cell shows similar cycling stability as the individual LGPS anode and LGPS cathode thus demonstrating a high Coulombic efficiency of both the pre-cycled LGPS anode and LGPS cathode during long-term charge/discharge cycles.

Single Material All-Solid State Lithium-Ion Battery and Single-Li₁₀GeP₂S₁₂ all-solid-state lithium-ion battery.

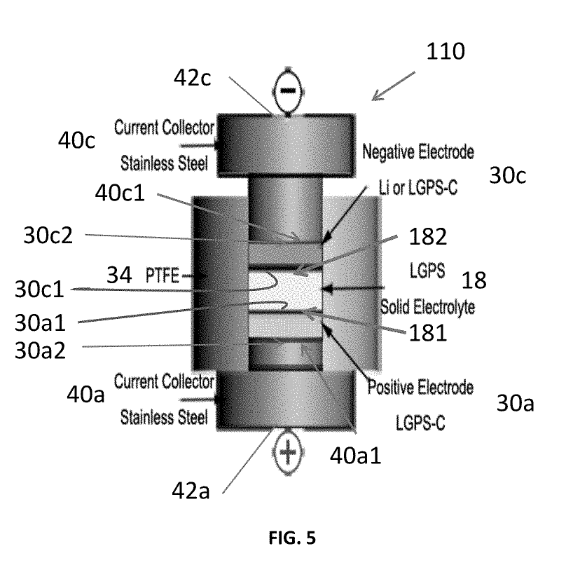

Therefore, as illustrated in FIGS. 1B and 5, solid solid-state lithium-ion battery 100 includes an anode 30a, a solid electrolyte layer of material 18; and a cathode 30c. The anode 30a and the cathode 30c each consist of the solid electrolyte material 18 and are interspersed with a current collector material, 12′ in anode 30a and 12″ in cathode 30c, such that electrical conductivity is enabled between the anode 30a and the cathode 30c via the solid electrolyte layer 18 to form thereby a solid state lithium ion battery made from a single material common to the anode 30a, the solid electrolyte layer 18 and the cathode 30c.

The single material in common for the solid electrolyte layer 18 and the anode 30a and the cathode 30c can be selected from, as examples, but are not limited to, the group consisting of Li₁₀GeP₂S₁₂, Li₃PS₄, Li₄GeS₄, Li₂S—SiS₂, Li₁₀SnP₂S₁₂, and LiVPO₄F.

The current collector material 12′ and 12″ may be carbon, or alternatively referred to herein as a carbon material.

The carbon or carbon material can be selected from, as examples, but is not limited to, the group consisting of graphite, acetylene black, Carbon Black Super P® Conductive, and carbon black.

Referring to FIG. 5, the solid-state lithium-ion battery 100 may further include a stainless steel current collector 40a in electrical communication with the current collector material 12′ interspersed in the anode 40a; and a stainless steel current collector 40c in electrical communication with the current collector material 12″ interspersed in the cathode 40c.

Referring again to FIG. 5 together with FIG. 1B, the feasibility of using the Li supertonic conductor LGPS electrolyte 18 as both the cathode 30c and anode 30a allows construction of a single-LGPS ASSLIB 100.

In an embodiment, the solid-state lithium-ion battery 100 may be constructed wherein the single material in common for the anode 30a; the single material in common for the solid electrolyte layer of material 18, and the single material for the cathode 30c consists of Li₁₀GeP₂S₁₂(LGPS). The anode 30a and the cathode 30c are interspersed with the current collector material 12′ and 12″, respectively, such that electrical conductivity is enabled between the anode 30a and the cathode 30c via the solid electrolyte layer 18 to form thereby the solid state lithium ion battery 100 made from a single material common to the anode, the solid electrolyte layer and the cathode.

Again, the current collector material 12′ and 12″ may be carbon, or alternatively referred to herein as a carbon material.

Additionally, the carbon or carbon material can be selected from, as examples, but is not limited to, the group consisting of graphite, acetylene black, Carbon Black Super P® Conductive, and carbon black.

Again referring to FIG. 5, the solid-state lithium-ion battery 100 may further include stainless steel current collector 40a in electrical communication with the current collector material 12′ interspersed in the anode 40a; and stainless steel current collector 40c in electrical communication with the current collector material 12″ interspersed in the cathode 40c.

Regarding a single Li₁₀GeP₂S₁₂all-solid-state lithium-ion battery, the electrochemical performances of all-solid-state batteries were tested in a specially-designed Swagelok cell 110, wherein the solid electrolyte 18 and electrodes 30c and 30a are cold-pressed sequentially between two stainless steel rods 40c and 40a inside an insulating PTFE tank 34. More particularly, the Li₁₀GeP₂S₁₂ anode and carbon current collector composite (LGPS/C) 30a and the Li₁₀GeP₂S₁₂ cathode and carbon current collector composite (LGPS/C) 30c are manufactured by depositing the Li₁₀GeP₂S₁₂/C anode and current collector composite 30a to form a first surface 30a1 on a first surface 181 of the LGPS solid electrolyte 18 to form an anode and current collector composite layer on the first surface 181 of the LGPS solid electrolyte layer 18. The process continues by depositing the Li₁₀GeP₂S₁₂/C cathode and current collector composite 30c to form a first surface 30c1 on a second surface 182 of the LGPS solid electrolyte 18 to form a cathode and current collector composite layer on the second surface 182 of the LGPS solid electrolyte layer 18.

The process further includes cold pressing the Li₁₀GeP₂S₁₂/C anode composite layer 30a1, the LGPS solid electrolyte layer 18, and the Li₁₀GeP₂S₁₂/C cathode composite layer 30c1 at 360 MPa to enable electrical conductivity between the anode composite layer and the cathode composite layer via the LGPS solid electrolyte layer to form thereby a solid state lithium ion battery made from a single material. The carbon 12′ contained in the carbon composite anode 30a and the carbon 12″ contained in the carbon composite cathode 30c act as current collectors. The solid-state lithium-ion battery 110 further includes a stainless steel current collector 40a in electrical communication with the carbon 12′contained in the carbon composite anode 30a and a stainless steel current collector 40c in electrical communication with the carbon 12″ contained in the carbon composite cathode 30c.

Referring also to FIG. 1B, the half-cell tests (Li/LGPS/LGPS-C) within different voltage ranges were first conducted to evaluate the performances of the LGPS 18 as a cathode (30c) and an anode (30a) in the all-solid-state configuration using LGPS as the solid electrolyte 18.

Discussion

The significant improvement of the interfacial behavior of the single-LGPS ASSLIB could be ascribed to the following reasons.

Using a single LGPS as both the electrodes (cathode and anode) and the electrolyte would allow an intimate physical contact between the electrodes and electrolyte at an atomic scale since the electrodes are essentially evolved from the electrolyte. For a conventional bulk-type ASSLIB with poor electronically-conductive electrodes, the charge transfer reaction usually occurs at the “triple phase contact” region where the active material is in contact with both the lithium ionic conductive solid electrolyte and the electronically-conductive carbon.⁵⁷ However, in the proposed single-LGPS ASSLIB, only a two-phase contact between carbon and solid electrolyte is required, which would effectively increase the active sites for electrochemical reaction. Since there is no carbon in the pure electrolyte layer and the electronic conductivity of LGPS cathode is very low, the progressive decomposition of the solid electrolyte would also be prevented.

The chemical reactions and elemental inter-diffusions between electrodes and electrolyte could be eliminated because the electrodes are essentially gradually evolved from the electrolyte. More importantly, a transition region with a smooth chemical-composition and potential gradient distribution could be formed across the electrodes and electrolyte.⁵⁸ The smooth electrochemical potential distribution will restrict the formation of space-charge layers between the electrodes and electrolyte.

The stress/strain generated at the interface would also be relieved because of the existence of the transition region across the electrodes and electrolyte. Consequently, a very low interfacial resistance could be achieved in the single-LGPS ASSLIB during long-term charge/discharge cycles. Besides the remarkably-decreased interfacial resistance in the single-LGPS ASSLIB, the addition of large amounts of solid electrolyte (˜50 wt. %) in the composite electrodes, which is usually required in a conventional bulk-type all-solid-state batteries 10 (See FIG. 1A) to ensure efficient transport of lithium ions and electrons in the electrode volume, would be unnecessary due to the electrode itself being highly ionic conductive. This would apparently contribute to the energy density of all-solid-state batteries.

In summary, a single-material battery using LGPS as an electrolyte, an anode and a cathode, may eliminate the highly-resistive interfacial resistance of ASSLIB. After mixing LGPS with carbon, the Li—S and Ge—S components in LGPS could act as active centers for its cathode and anode performance in a way similar to the Li₂S cathode and GeS₂ anode, respectively. The single-LGPS ASSLIB exhibited a remarkably low interfacial resistance due to:

the improvement of interfacial contact,

the modification of the interfacial interactions, and

the suppression of the strain/stress at the interface.

The single-material battery concept provides a new direction to address the most challenging interfacial problem in all-solid-state lithium-ion battery. This concept is not limited to the use of LGPS, and it can also be broadly applied to other solid-state battery systems, beneficial to a high-power, high-energy, long-cycling all-solid-state battery. Additional implications of this concept include the fabrication of a nano-battery by introducing electronically-conductive material on the both surfaces of the LGPS nanomaterials.

Methods

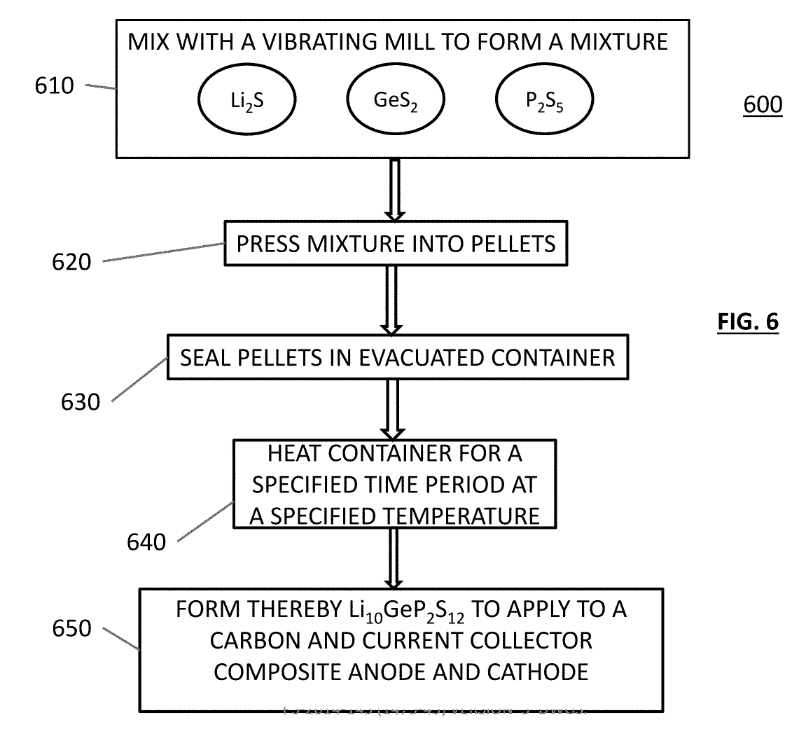

Synthesis. FIG. 6 illustrates a method 600 of manufacturing LGPS solid electrolyte Li₁₀GeP₂S₁₂. as known in the art (7, Kamaya et al.). It is utilized herein to include LGPS solid electrolyte Li₁₀GeP₂S₁₂ as part of the cathode composite layer 30c and as part of the anode composite layer 30a after mixing the cathode composite layer 30c and the anode composite layer 30a with carbon (12″ and 12′, respectively, in FIG. 1B).

Accordingly, to prepare the cathode composite layer 30c and the anode composite layer 30a, as well as the solid electrolyte layer 18, Li₂S (Sigma-Aldrich, 99.98%), P₂5₅ (Sigma-Aldrich, 99%) and GeS₂ (MP Biomedicals LLC, 99.99%) were used as starting materials. Step 610 of mixing with a vibrating mill to form a mixture includes wherein these materials were weighed in the molar ratio of Li₂S/P₂S₂/GeS₂=5/1/1 in an argon (Ar)-filled glove box, subjected to a zirconia ceramic vial and mixed for 30 minutes using a high energy vibrating mill (SPEX SamplePrep* 8000M Mixer/Mill).

Step 620 of pressing the mixture into pellets includes wherein the powder obtained in step 610 was then pressed into pellets.

Step 630 includes sealing the pellets in an evacuated container, e.g., an evacuated quartz tube, at less than or equal to 30 Pa. Step 640 includes heating the pellets sealed in the evacuated container at 550° C. for 8 h in a furnace placed inside a glove box. Subsequently, in step 650, the resulting sample is then naturally cooled down to the ambient temperature to form Li₁₀GeP₂S₁₂ . . . to apply to the Li₁₀GeP₂S₁₂ carbon current collector and (LGPS/C) anode composite 30a and the Li₁₀GeP₂S₁₂ carbon current collector and composite (LGPS/C) cathode composite 30c

In an embodiment, step 640 includes heating the evacuated container at a temperature included in a temperature range that includes 550° C. and may include heating the evacuated container at a temperature ranging from 100° C. to 1000° C. In an embodiment, step 640 includes heating the evacuated container at a temperature ranging from 100° C. to 1000° C. includes heating the evacuated container at a temperature ranging from 200° C. to 900° C.

In an embodiment, step 640 includes heating the evacuated container at a temperature ranging from 200° C. to 900° C. includes heating the evacuated container at a temperature ranging from 300° C. to 800° C.

In an embodiment, step 640 includes heating the evacuated container at a temperature ranging from 300° C. to 800° C. includes heating the evacuated container at a temperature ranging from 400° C. to 700° C. In an embodiment, step 640 includes heating the evacuated container at a temperature ranging from 400° C. to 700° C. includes heating the evacuated container at a temperature ranging from 500° C. to 600° C. In an embodiment, step 640 includes heating the evacuated container at a temperature and for a time period sufficient to form Li₁₀GeP₂S₁₂includes heating the evacuated container for a time period included in a time period range that includes 8 hours, In an embodiment, step 640 includes heating the evacuated container for a time period included in a time period range that includes 8 hours includes heating the evacuated container for a time period ranging from 2 to 14 hours.

In an embodiment, step 640 includes heating the evacuated container for a time period ranging from 2 to 14 hours includes heating the evacuated container for a time period ranging from 3 to 13 hours.

In an embodiment, step 640 includes heating the evacuated container for a time period ranging from 3 to 13 hours includes heating the evacuated container for a time period ranging from 4 to 12 hours.

In an embodiment, step 640 includes heating the evacuated container for a time period ranging from 4 to 12 hours includes heating the evacuated container for a time period ranging from 5 to 11 hours.

In an embodiment, step 640 includes heating the evacuated container for a time period ranging from 5 to 11 hours includes heating the evacuated container for a time period ranging from 6 to 10 hours.

In an embodiment, step 640 includes heating the evacuated container for a time period ranging from 6 to 10 hours includes heating the evacuated container for a time period ranging from 7 to 9 hours.

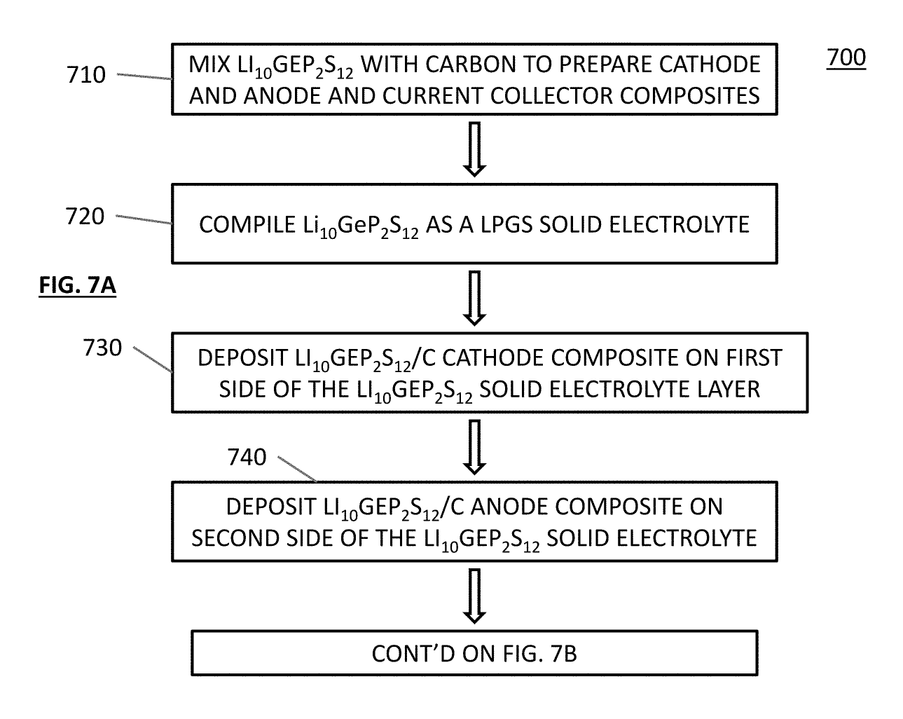

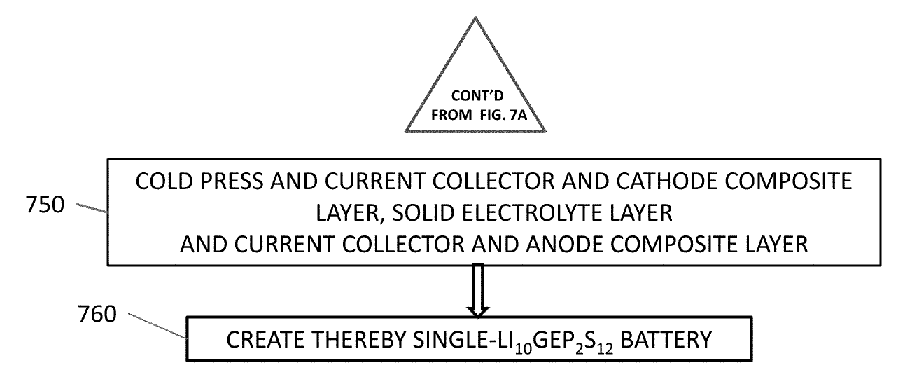

FIGS. 7A and 7B, in conjunction with FIGS. 1B and 5, illustrate a method 700 of manufacturing the solid-state lithium-ion battery 100.

Step 710 includes mixing Li₁₀GeP₂S₁₂ with carbon black to prepare a Li₁₀GeP₂S₁₂/C cathode composite and an Li₁₀GeP₂S₁₂/C anode composite.

Step 720 includes compiling Li₁₀GeP₂S₁₂ powder as a LGPS solid electrolyte.

Step 730 includes depositing a Li₁₀GeP₂S₁₂C anode composite on first surface 181 of LGPS solid electrolyte 18 to form an anode composite layer 30a on the first surface 181 of the LGPS solid electrolyte layer 18.

Step 740 includes depositing a Li₁₀GeP₂S₁₂C cathode composite on second surface 182 of the LGPS solid electrolyte 18 to form a cathode composite layer 30c on the second surface 182 of the LGPS solid electrolyte layer 18.

Step 750 includes cold pressing the Li₁₀GeP₂S₁₂/C anode composite layer 30a, the LGPS solid electrolyte layer 18, and the Li₁₀GeP₂S₁₂C cathode composite layer 30c at a pressure sufficient to enable electrical conductivity between the anode composite layer 30a and the cathode composite layer 30c via the LGPS solid electrolyte layer 18, e.g., at 360 MPa, to form thereby the solid state lithium ion battery 100 that is made from a single material.

In an embodiment, step 750 includes wherein the cold pressing the Li₁₀GeP₂S₁₂/C anode composite layer, the LGPS solid electrolyte layer, and the Li₁₀GeP₂S₁₂/C cathode composite layer at a pressure sufficient to enable electrical conductivity between the anode composite layer and the cathode composite layer via the LGPS solid electrolyte layer includes cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa.

In an embodiment, step 750 includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa.

In an embodiment, step 750 includes wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa.

In an embodiment, step 750 includes wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa.

In an embodiment, step 750 includes wherein the cold pressing the Li₁₀GeP₂S₁₂/C anode composite layer, the LGPS solid electrolyte layer, and Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

In an embodiment, step 750 includes wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

In an embodiment, step 750 includes wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa includes cold pressing the Li ₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa.

In an embodiment, step 750 includes wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 300 MPa to 500 MPa.

Characterization.

Powder X-ray diffraction patterns were obtained with a D8 Advance with LynxEye and SolX (Bruker AXS, WI, USA) using CuKα radiation.

The P/Ge ratio was determined by inductively coupled plasma spectroscopy (Perkin-Elmer ICP-OES).

The morphology of the sample was examined using a Hitachi a SU-70 field-emission scanning electron microscope.

The surface chemistry of the samples was examined by X-ray photoelectron spectroscopy using a Kratos Axis 165 spectrometer.

To prepare the sample for XPS test, LGPS electrodes were charged or discharged to a certain voltage in a liquid electrolyte using a Swagelok cell, and held at that voltage for 24 h.

The electrodes were then taken out from the cell, and rinsed by dimethoxyethane (DME) inside the glove box.

All samples were dried under vacuum overnight, placed in a sealed bag, and then transferred into the XPS chamber under inert conditions in a nitrogen-filled glove bag.

Ar⁺ sputtering was performed for 180 s on the surface of the discharged and charged LGPS anodes to remove the SEI layer.

XPS data was collected using a monochromated Al Kα X-ray source (1486.7 eV). The working pressure of the chamber was lower than 6.6×10⁻⁹ Pa. All reported binding energy values are calibrated to the C 1s peak at 284.8 eV.

Electrochemistry.

The LGPS powder was pressed into a pellet (diameter 13 mm; thickness ˜2 mm) in an Ar atmosphere.

It was then sputtered with Au to form an electrode for the ionic conductivity measurement.

The electrochemical impedance spectrums of the Au/LGPS/Au cell were measured between 23 and 132° C. by applying a 100 mV amplitude AC potential in a frequency range of 10 MHz to 0.1 Hz.

The cyclic voltammogram of the Li/LGPS/Pt cell was measured between −0.6 and 5.0 V with a scan rate of 0.05 mV/s. The electrochemical performances of LGPS electrodes were firstly tested using a liquid electrolyte with Celgard 3501 as the separator in either two- or three-electrode Swagelok cells. 1M lithium bis(trifluoromethanesulfonyl)imide (LiTFSI) in a mixture of 1:1 volume ratio of tetraethylene glycol dimethyl ether (TEGDME) and n-methyl-(n-butyl) pyrrolidinium bis(trifluoromethanesulfonyl)imide (PYR₁₃TFSI) was used as the liquid electrolyte.

Composite electrodes consisting of LGPS and carbon black with a weight ratio of 75:25 were prepared by hand-grinding in the mortar, which were then mixed with 10 wt. % polyvinylidene fluoride (PVDF) and n-methylpyrrolidinone (NMP) to make the electrode slurries.

The electrodes were prepared by casting these slurries onto stainless steel, copper or aluminum foils and drying at 110° C. overnight inside the glove box.

Half-cells were assembled using a lithium metal foil as the counter electrode, and full cells in the liquid electrolyte were assembled with an electrode mass ratio of ˜1 between the cathode and the anode sides.

For the all-solid-state lithium-ion battery test, LGPS powder (120 mg) was pressed into a pellet with a diameter of 13 mm under 360 Mpa, which was used as solid electrolyte.

The as-obtained solid electrolyte was then sandwiched between LGPS/C cathode and LGPS/C anode (or Li metal) to constitute an all-solid-state cell by pressing under 120 Mpa. The mass of the composite electrode is about 10 mg.

The three-layered pellet was then sandwiched between two stainless-steel rods as current collectors.

Both the electrode preparation and cell assembly were performed in the Ar-filled glove box. The charge/discharge behavior was tested using an ArbinBT2000 workstation (Arbin Instruments, Tex., USA) at room temperature.

The electrochemical impedance spectrum and cyclic voltammetry measurements were carried on an electrochemistry workstation (Solartron 1287/1260).

Although the single-material battery based on Li₁₀GeP₂S₁₂ as the solid electrolyte layer 18 was illustrated here, it should be noted that the single-battery concept is not limited to this material. Any solid electrolytes that have reversible decompositions at two different voltages could function as the material for the carbon composite anode layer 30a, the carbon composite cathode layer 30c, and the solid electrolyte layer of material 18 of the single material battery 100 (see FIG. 1B). The examples for these materials included but are not limited to Li₃PS₄, Li₄GeS₄, Li₁₀S—SiS₂, Li₁₀SnP₂S₁₂, LiVPO₄F.

Thus, referring again to FIGS. 1B and 5, the present disclosure relates to solid-state lithium-ion battery 100 that includes anode 30a, solid electrolyte layer of material 18, and cathode 30c, wherein the anode 30a and the cathode 30c consist of the material of the solid electrolyte layer 18 and are interspersed with current collector material 12′ and 12″, respectively such that electrical conductivity is enabled between the anode 30a and the cathode 30c via the solid electrolyte layer to form thereby the solid state lithium ion battery 100 made from a single material common to the anode 30a, the solid electrolyte layer 18 and the cathode 30c.

In embodiments, the material for the solid electrolyte layer 18 and the material interspersed with carbon in the carbon composite anode 30a and in the carbon composite cathode 30c is selected from the group consisting of Li₃PS₄, Li₄GeS₄, Li₂S—SiS₂, Li₁₀SnP₂S₁₂, and LiVPO₄F, and may include other materials apparent to those skilled in the art.

The method 700 of manufacturing the solid-state lithium-ion battery 100, as illustrated in FIGS. 7A and 7B, and described above, may be analogously employed by those skilled in the art to assemble the battery 100 utilizing one of the foregoing materials in the group consisting of Li₃PS₄, Li₄GeS₄, Li₂S—SiS₂, Li₁₀SnP₂S₁₂, and LiVPO₄F, and may be analogously employed utilizing other materials or other materials not specifically identified that are apparent to those skilled in the art.

In an embodiment, the carbon composite anode 30a consists of a Li₁₀GeP₂S₁₂ carbon composite (LGPS/C) anode, the solid electrolyte layer of material 18 is a LGPS solid electrolyte layer, and the carbon composite cathode 30a consists of a Li₁₀GeP₂S₁₂carbon composite (LGPS/C) cathode, such that electrical conductivity is enabled between the carbon composite anode 30a and the carbon composite cathode 30c via the LGPS solid electrolyte layer 18 to form thereby the solid state lithium ion battery made from a single material.

While several embodiments and methodologies of the present disclosure have been described and shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular embodiments and methodologies. Those skilled in the art will envision other modifications within the scope of the claims appended hereto.

### REFERENCES

1. Xu, K. Nonaqueous liquid electrolytes for lithium-based rechargeable batteries. Chem. Rev. 104, 4303-4417 (2004).
2. Tarascon, J. M. & Armand, M. Issues and challenges facing rechargeable lithium batteries. Nature 414, 359-367 (2001).
3. Bates, J. B., Dudney, N. J., Neudecker, B., Ueda, A. & Evans, C. D. Thin-film lithium and lithium-ion batteries. Solid State Ion. 135, 33-45 (2000).
4. Souquet, J. L. & Duclot, M. Thin film lithium batteries. Solid State Ion. 148, 375-379 (2002).
5. Minami, T. et al. Solid state ionics for batteries. (Springer, 2005).
6. Murugan, R., Thangadurai, V. & Weppner, W. Fast lithium ion conduction in garnet-type Li₇La₃Zr₂O₁₂. Angew. Chem. Int. Ed. 46, 7778-7781 (2007).
7. Kamaya, N. et al. A lithium superionic conductor. Nat. Mater. 10, 682-686 (2011).
8. Seino, Y., Ota, T., Takada, K., Hayashi, A. & Tatsumisago, M. A sulphide lithium super ion conductor is superior to liquid ion conductors for use in rechargeable batteries. Energy Environ. Sci. 7, 627-631 (2014).
9. Tatsumisago, M., Mizuno, F. & Hayashi, A. All-solid-state lithium secondary batteries using sulfide-based glass-ceramic electrolytes. J. Power Sources 159, 193-199 (2006).
10. Takada, K. et al. Solid state batteries with sulfide-based solid electrolytes. Solid State Ion. 172, 25-30 (2004).
11. Yersak, T. A., Stoldt, C. & Lee, S. H. Electrochemical evolution of an iron sulfide and sulfur based cathode for all-solid-state Li-ion batteries. J. Electrochem. Soc. 160, A1009-A1015 (2013).
12. Jin, Y. & McGinn, P. J. Li₇La₃Zr₂O₁₂ electrolyte stability in air and fabrication of a Li/Li₇La₃Zr₂O₁₂/Cu_{0.1}V₂O₅ solid-state battery. J. Power Sources 239, 326-331 (2013).
13. Takada, K. Interfacial nanoarchitectonics for solid-state lithium batteries. Langmuir 29, 7538-7541 (2013).
14. Nagao, M., Hayashi, A. & Tatsumisago, M. High-capacity Li₂S-nanocarbon composite electrode for all-solid-state rechargeable lithium batteries. J. Mater. Chem. 22, 10015-10020 (2012).
15. Jak, M. J. G. et al. Composite cell components for elevated temperature all-solid-state Li-ion batteries. Solid State Ion. 143, 57-66 (2001).
16. Birke, P., Salam, F., Doring, S. & Weppner, W. A first approach to a monolithic all solid state inorganic lithium battery. Solid State Ion. 118, 149-157 (1999).
17. Chen, K., Shen, Y., Zhang, Y. B., Lin, Y. H. & Nan, C. W. High capacity and cyclic performance in a three-dimensional composite electrode filled with inorganic solid electrolyte. J. Power Sources 249, 306-310 (2014).
18. Ohta, S. et al. All-solid-state lithium ion battery using garnet-type oxide and Li₃BO₃ solid electrolytes fabricated by screen-printing. J. Power Sources 238, 53-56 (2013).
19. Rosciano, F. et al. Towards a lattice-matching solid-state battery: synthesis of a new class of lithium-ion conductors with the spinel structure. Phys. Chem. Chem. Phys. 15, 6107-6112 (2013).
20. Aboulaich, A. et al. A new approach to develop safe all-inorganic monolithic Li-ion batteries. Adv. Energy Mater. 1, 179-183 (2011).
21. Delaizir, G. et al. The stone age revisited: building a monolithic inorganic lithium-ion battery. Adv. Funct. Mater. 22, 2140-2147 (2012).
22. Xie, J. et al. Li-ion transport in all-solid-state lithium batteries with LiCoO₂ using NASICON-type glass ceramic electrolytes. J. Power Sources 189, 365-370 (2009).
23. Kim, K. H. et al. Characterization of the interface between LiCoO₂ and Li₇La₃Zr₂O₁₂ in an all-solid-state rechargeable lithium battery. J. Power Sources 196, 764-767 (2011).
24. Kobayashi, T., Yamada, A. & Kanno, R. Interfacial reactions at electrode/electrolyte boundary in all solid-state lithium battery using inorganic solid electrolyte, thio-LISICON. Electrochim. Acta 53, 5045-5050 (2008).
25. Jeong, E., Chan, H. A., Tak, Y., Nam, S. C. & Cho, S. Investigation of interfacial resistance between LiCoO₂ cathode and LiPON electrolyte in the thin film battery. J. Power Sources 159, 223-226 (2006).
26. Sakuda, A., Hayashi, A. & Tatsumisago, M. Interfacial observation between LiCoO₂ electrode and Li₂S—P₂S₅ solid electrolytes of all-solid-state lithium secondary batteries using transmission electron microscopy. Chem. Mater. 22, 949-956 (2009).
27. Ohta, N. et al. Enhancement of the high-rate capability of solid-state lithium batteries by nanoscale interfacial modification. Adv. Mater. 18, 2226-2229 (2006).
28. Haruyama, J., Sodeyama, K., Han, L., Takada, K. & Tateyama, Y. Space-charge layer effect at interface between oxide cathode and sulfide electrolyte in all-solid-state lithium-ion battery. Chem. Mater. 26, 4248-4255 (2014).
29. Maier, J. Nanoionics: ion transport and electrochemical storage in confined systems. Nat. Mater. 4, 805-815 (2005).
30. Sakuda, A., Hayashi, A., Ohtomo, T., Hama, S. & Tatsumisago, M. All-solid-state lithium secondary batteries using LiCoO₂ particles with pulsed laser deposition coatings of Li₂S—P₂S₅ solid electrolytes. J. Power Sources 196, 6735-6741 (2011).
31. Cervera, R. B. et al. High performance silicon-based anodes in solid-state lithium batteries. Energy Environ. Sci. 7, 662-666 (2014).
32. Woo, J. H. et al. Nanoscale interface modification of LiCoO₂ by Al₂O₃ atomic layer deposition for solid-state Li batteries. J. Electrochem. Soc. 159, A1120-A1124 (2012).
33. Okumura, T. et al. Depth-resolved X-ray absorption spectroscopic study on nanoscale observation of the electrode-solid electrolyte interface for all solid state lithium ion batteries. J. Mater. Chem. 21, 10051-10060 (2011).
34. Wessells, C., Ruffo, R., Huggins, R. A. & Cui, Y. Investigations of the electrochemical stability of aqueous electrolytes for lithium battery applications. Electrochem. Solid-State Lett. 13, A59-A61 (2010).
35. Birke, P., Scharner, S., Huggins, R. A. & Weppner, W. Electrolytic stability limit and rapid lithium insertion in the fast-ion-conducting Li_{0.29}La_{0.57}TiO₃ perovskite-type compound. J. Electrochem. Soc. 144, L167-L169 (1997).
36. Yada, C., Iriyama, Y., Abe, T., Kikuchi, K. & Ogumi, Z. A novel all-solid-state thin-film-type lithium-ion battery with in situ prepared positive and negative electrode materials. Electrochem. Commun. 11, 413-416 (2009).
37. Kato, Y., Kawamoto, K., Kanno, R. & Hirayama, M. Discharge performance of all-solid-state battery using a lithium supertonic conductor Li₁₀GeP₂S₁₂. Electrochemistry 80, 749-751 (2012).
38. Hassoun, J. et al. A structural, spectroscopic and electrochemical study of a lithium ion conducting Li₁₀GeP₂S₁₂ solid electrolyte. J. Power Sources 229, 117-122 (2013).
39. Mo, Y. F., Ong, S. P. & Ceder, G. First principles study of the Li₁₀GeP₂S₁₂ lithium super ionic conductor material. Chem. Mater. 24, 15-17 (2012).
40. Yang, Y. et al. High-capacity micrometer-sized Li₂S particles as cathode materials for advanced rechargeable lithium-ion batteries. J. Am. Chem. Soc. 134, 15387-15394 (2012).
41. Idota, Y., Kubota, T., Matsufuji, A., Maekawa, Y. & Miyasaka, T. Tin-based amorphous oxide: A high-capacity lithium-ion-storage material. Science 276, 1395-1397 (1997).
42. Kim, Y., Hwang, H., Lawler, K., Martin, S. W. & Cho, J. Electrochemical behavior of Ge and GeX₂ (X═O, S) glasses: Improved reversibility of the reaction of Li with Ge in a sulfide medium. Electrochim. Acta 53, 5058-5064 (2008).
43. Cho, Y. J. et al. Germanium sulfide (II and IV) nanoparticles for enhanced performance of lithium ion batteries. Chem. Commun. 49, 4661-4663 (2013).
44. Guo, J., Yang, Z., Yu, Y., Abruna, H. D. & Archer, L. A. Lithium-sulfur battery cathode enabled by lithium-nitrile interaction. J. Am. Chem. Soc. 135, 763-767 (2013).
45. Ji, X., Lee, K. T. & Nazar, L. F. A highly ordered nanostructured carbon-sulphur cathode for lithium-sulphur batteries. Nat. Mater. 8, 500-506 (2009).
46. Zhang, S. S. Liquid electrolyte lithium/sulfur battery: Fundamental chemistry, problems, and solutions. J. Power Sources 231, 153-162 (2013).
47. Mikhaylik, Y. V. & Akridge, J. R. Polysulfide shuttle study in the Li/S battery system. J. Electrochem. Soc. 151, A1969-A1976 (2004).
48. Suo, L., Hu, Y. S., Li, H., Armand, M. & Chen, L. A new class of Solvent-in-Salt electrolyte for high-energy rechargeable metallic lithium batteries. Nat. Commun. 4, 1481 (2013).
49. Huang, C. et al. Manipulating surface reactions in lithium-sulphur batteries using hybrid anode structures. Nat. Commun. 5, 3015 (2014).
50. Kim, H. S. et al. Structure and compatibility of a magnesium electrolyte with a sulphur cathode. Nat. Commun. 2, 427 (2011).
51. Su, Y. S., Fu, Y., Cochell, T. & Manthiram, A. A strategic approach to recharging lithium-sulphur batteries for long cycle life. Nat. Commun. 4, 2985 (2013).
52. Saffarini, G. & Saiter, J. X-ray photoelectron spectroscopic measurements on glassy Ge₂₀S₈₀₋ₓBiₓ(x=0, 16). Mater. Lett. 46, 327-331 (2000).
53. Timbrell, P., Puchert, M. & Lamb, R. X-ray photoelectron imaging of germanosilicate optical fibre preforms. Surf Interface Anal. 21, 731-736 (1994).
54. Prabhakaran, K. & Ogino, T. Oxidation of Ge (100) and Ge (111) surfaces: an UPS and XPS study. Surf Sci. 325, 263-271 (1995).
55. Noguchi, Y., Kobayashi, E., Plashnitsa, L. S., Okada, S. & Yamaki, J. Fabrication and performances of all solid-state symmetric sodium battery based on NASICON-related compounds. Electrochim. Acta 101, 59-65 (2013).
56. Ohtomo, T. et al. All-solid-state lithium secondary batteries using the 75Li₂S.25P₂S₅ glass and the 70Li2S.30P₂S₅ glass-ceramic as solid electrolytes. J. Power Sources 233, 231-235 (2013).
57. Machida, N., Maeda, H., Peng, H. & Shigematsu, T. All-solid-state lithium battery with LiCo_{0.3}Ni_{0.7}O₂ fine powder as cathode materials with an amorphous sulfide electrolyte. J. Electrochem. Soc. 149, A688-A693 (2002).
58. Yamamoto, K. et al. Direct observation of lithium-ion movement around an in-situ-formed-negative-electrode/solid-state-electrolyte interface during initial charge-discharge reaction. Electrochem. Commun. 20, 113-116 (2012).

What is claimed is:

1. A solid-state lithium-ion battery comprising:
an anode;
a solid electrolyte layer of material; and
a cathode,
wherein the anode and the cathode each consist of the solid electrolyte material and are interspersed with a current collector material such that electrical conductivity is enabled between the anode and the cathode via the solid electrolyte layer to form thereby a solid state lithium ion battery made from a single material common to the anode, the solid electrolyte layer and the cathode.

2. The solid-state lithium-ion battery according to claim 1, wherein the single material in common for the solid electrolyte layer and the anode and the cathode is selected from the group consisting of Li₁₀GeP₂S₁₂, Li₃PS₄, Li₄GeS₄, Li₂S—SiS₂, Li₁₀SnP₂S₁₂, and LiVPO₄F.

3. The solid-state lithium-ion battery according to claim 1, wherein the current collector material is carbon.

4. The solid-state lithium-ion battery according to claim 3, wherein the carbon is selected from the group consisting of graphite, acetylene black, Carbon Black Super P® Conductive, and carbon black.

5. The solid-state lithium-ion battery according to claim 1, further comprising:
a stainless steel current collector in electrical communication with the current collector material interspersed in the anode; and
a stainless steel current collector in electrical communication with the current collector material interspersed in the cathode.

6. The solid-state lithium-ion battery according to claim 1,
wherein the single material in common for the anode;
the single material in common for the solid electrolyte layer of material, and
the single material for the cathode consists of Li₁₀GeP₂S₁₂ (LGPS),
wherein the anode and the cathode are interspersed with the current collector material such that electrical conductivity is enabled between the anode and the cathode via the solid electrolyte layer to form thereby the solid state lithium ion battery made from a single material in common to the anode, the solid electrolyte layer and the cathode.

7. The solid-state lithium-ion battery according to claim 6, wherein the current collector material is carbon.

8. The solid-state lithium-ion battery according to claim 7, wherein the carbon is selected from the group consisting of graphite, acetylene black, Carbon Black Super P® Conductive, and carbon black.

9. The solid-state lithium-ion battery according to claim 6, wherein the LGPS solid electrolyte is manufactured by:
mixing Li₂S, GeS₂, and P₂S₅ in a vibrating mill to form a mixture;
pressing the mixture into pellets;
sealing the pellets in an evacuated container: and heating the evacuated container at a temperature and for a time period sufficient to form Li₁₀GeP₂S₁₂

10. The solid-state lithium-ion battery according to claim 9, wherein the sealing in and heating of the evacuated container include sealing the pellets in and heating an evacuated quartz tube.

11. The solid-state lithium-ion battery according to claim 9, wherein heating the evacuated container includes heating the evacuated container at a temperature included in a temperature range that includes 550° C.

12. The solid-state lithium-ion battery according to claim 11, wherein the heating the evacuated container at a temperature included in a temperature range that includes 550° C. includes heating the evacuated container at a temperature ranging from 100° C. to 1000° C.

13. The solid-state lithium-ion battery according to claim 12, wherein the heating the evacuated container at a temperature ranging from 100° C. to 1000° C. includes heating the evacuated container at a temperature ranging from 200° C. to 900° C.

14. The solid-state lithium-ion battery according to claim 13, wherein the heating the evacuated container at a temperature ranging from 200° C. to 900° C. includes heating the evacuated container at a temperature ranging from 300° C. to 800° C.

15. The solid-state lithium-ion battery according to claim 14, wherein the heating the evacuated container at a temperature ranging from 300° C. to 800° C. includes heating the evacuated container at a temperature ranging from 400° C. to 700° C.

16. The solid-state lithium-ion battery according to claim 15, wherein the heating the evacuated container at a temperature ranging from 400° C. to 700° C. includes heating the evacuated container at a temperature ranging from 500° C. to 600° C.

17. The solid-state lithium-ion battery according to claim 9, wherein the heating the evacuated container at a temperature and for a time period sufficient to form Li₁₀GeP₂S₁₂ includes heating the evacuated container for a time period included in a time period range that includes 8 hours,

18. The solid-state lithium-ion battery according to claim 17, wherein the heating the evacuated container for a time period included in a time period range that includes 8 hours includes heating the evacuated container for a time period ranging from 2 to 14 hours.

19. The solid-state lithium-ion battery according to claim 18, wherein heating the evacuated container for a time period ranging from 2 to 14 hours includes heating the evacuated container for a time period ranging from 3 to 13 hours.

20. The solid-state lithium-ion battery according to claim 19, wherein heating the evacuated container for a time period ranging from 3 to 13 hours includes heating the evacuated container for a time period ranging from 4 to 12 hours.

21. The solid-state lithium-ion battery according to claim 20, wherein heating the evacuated container for a time period ranging from 4 to 12 hours includes heating the evacuated container for a time period ranging from 5 to 11 hours.

22. The solid-state lithium-ion battery according to claim 21, wherein heating the evacuated container for a time period ranging from 5 to 11 hours includes heating the evacuated container for a time period ranging from 6 to 10 hours.

23. The solid-state lithium-ion battery according to claim 22, wherein heating the evacuated container for a time period ranging from 6 to 10 hours includes heating the evacuated container for a time period ranging from 7 to 9 hours.

24. The solid-state lithium-ion battery according to claim 6, wherein the Li₁₀GeP₂S₁₂ anode and the carbon current collector material (LGPS/C) and the Li₁₀GeP₂S₁₂ cathode and the carbon current collector material (LGPS/C) are manufactured by:
mixing the Li₁₀GeP₂S₁₂ with a carbon material to prepare a Li₁₀GeP₂S₁₂/C cathode composite and an Li₁₀GeP₂S₁₂C anode composite;
compiling Li₁₀GeP₂S₁₂ powder as a LGPS solid electrolyte;
depositing the Li₁₀GeP₂S₁₂ [symbol] anode composite on a first surface of the LGPS solid electrolyte to form an anode and current collector composite layer on the first surface of the LGPS solid electrolyte layer;
depositing the Li₁₀GeP₂S₁₂ [symbol] cathode composite on a second surface of the LGPS solid electrolyte to form a cathode and current collector composite layer on the second surface of the LGPS solid electrolyte layer; and
cold pressing the Li₁₀GeP₂S₁₂/C anode and current collector composite layer, the LGPS solid electrolyte layer, and the Li₁₀GeP₂S₁₂/C cathode and current collector composite layer at a pressure sufficient to enable electrical conductivity between the anode and current collector composite layer and the cathode and current collector composite layer via the LGPS solid electrolyte layer to form thereby the solid state lithium ion battery made from a single material.

25. The solid-state lithium-ion battery according to claim 24, wherein the cold pressing the Li₁₀GeP₂S₁₂/C anode composite layer, the LGPS solid electrolyte layer, and the Li₁₀GeP₂S₁₂/C cathode composite layer at a pressure sufficient to enable electrical conductivity between the anode composite layer and the cathode composite layer via the LGPS solid electrolyte layer includes cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa.

26. The solid-state lithium-ion battery according to claim 25, wherein the cold pressing the Li₁₀GeP₂S₁₂/C anode composite layer, the LGPS solid electrolyte layer, Li₁₀GeP₂S₁₂/C cathode composite layer at a pressure in a pressure range that includes 360 MPa includes cold pressing Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa.

27. The solid-state lithium-ion battery according to claim 26, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa.

28. The solid-state lithium-ion battery according to claim 27, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa.

29. The solid-state lithium-ion battery according to claim 28, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

30. The solid-state lithium-ion battery according to claim 29, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

31. The solid-state lithium-ion battery according to claim 30, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa.

32. The solid-state lithium-ion battery according to claim 31, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 300 MPa to 500 MPa.

33. A method of manufacturing a solid-state lithium-ion battery comprising:
mixing Li₁₀GeP₂S₁₂ with a carbon material to prepare a Li₁₀GeP₂S₁₂/C cathode composite and an Li₁₀GeP₂S₁₂/C anode composite;
compiling Li₁₀GeP₂S₁₂ powder as a LGPS solid electrolyte;
depositing a Li₁₀GeP₂S₁₂/C anode composite on a first surface of an LGPS solid electrolyte to form an anode and current collector composite layer on the first surface of the LGPS solid electrolyte layer;
depositing a Li₁₀GeP₂S₁₂/C cathode composite on a second surface of the LGPS solid electrolyte to form a cathode and current collector composite layer on the second surface of the LGPS solid electrolyte layer; and
cold pressing the Li₁₀GeP₂S₁₂/C anode and current collector composite layer, the LGPS solid electrolyte layer, and the Li₁₀GeP₂S₁₂/C cathode and current collector composite layer at a pressure sufficient to enable electrical conductivity between the anode and current collector composite layer and the cathode and current collector composite layer via the LGPS solid electrolyte layer to form thereby a solid state lithium ion battery made from a single material.

34. The method of manufacturing a solid-state lithium-ion battery according to claim 33, wherein the cold pressing the Li₁₀GeP₂S₁₂/C anode composite layer, the LGPS solid electrolyte layer, and the Li₁₀GeP₂S₁₂/C cathode composite layer at a pressure sufficient to enable electrical conductivity between the anode composite layer and the cathode composite layer via the LGPS solid electrolyte layer includes cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa.

35. The method of manufacturing a solid-state lithium-ion battery according to claim 34, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that includes 360 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa.

36. The method of manufacturing a solid-state lithium-ion battery according to claim 35, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 10 MPa to 1000 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa.

37. The method of manufacturing a solid-state lithium-ion battery according to claim 36, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 100 MPa to 900 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa.

38. The method of manufacturing a solid-state lithium-ion battery according to claim 37, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

39. The method of manufacturing a solid-state lithium-ion battery according to claim 38, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 150 MPa to 800 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa.

40. The method of manufacturing a solid-state lithium-ion battery according to claim 39, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 200 MPa to 700 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa.

41. The method of manufacturing a solid-state lithium-ion battery according to claim 40, wherein the cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 250 MPa to 600 MPa includes cold pressing the Li₁₀GeP₂S₁₂/C anode composite layer, the LGPS solid electrolyte layer, and the Li₁₀GeP₂S₁₂/C cathode composite layer at a pressure in a pressure range that ranges from 300 MPa to 500 MPa.
